(19) United States
(12) Patent Application Publication
(10) Pub. No.: US 2014/0001153 A1
(43) Pub. Date: Jan. 2, 2014

(54) POLISHING SLURRY AND POLISHING METHOD THEREOF

(71) Applicants: Masayuki Matsuyama, Tokyo (JP); Mikimasa Horiuchi, Tokyo (JP)

(72) Inventors: Masayuki Matsuyama, Tokyo (JP); Mikimasa Horiuchi, Tokyo (JP)

(73) Assignee: MITSUI MINING & SMELTING CO., LTD., Tokyo (JP)

(21) Appl. No.: 14/005,070

(22) PCT Filed: Nov. 24, 2011
(86) PCT No.: PCT/JP2011/077008

§ 371 Date: Sep. 13, 2013

(30) Foreign Application Priority Data
Mar. 29, 2011 (JP) 2011-071790

(51) Int. Cl. C09G 1/02

(52) U.S. Cl. CPC C09G 1/02
USPC 216/38; 252/79.1; 252/79.2

(57) ABSTRACT

The present invention provides a polishing technique capable of polishing, at a high speed, a substrate containing Al and having high hardness, such as single-crystal sapphire substrate, and capable of providing a polished surface of high accuracy. The present invention relates to a polishing slurry for polishing a substrate containing aluminum, comprising abrasive grains, an inorganic boron compound having a solubility in water at 20° C. of 0.1 g/100 g—H₂O or more, and water. In the present invention, it is preferable that the content of the inorganic boron compound is 0.1% by mass to 20% by mass in terms of boron atoms based on the polishing slurry.

### BACKGROUND OF THE INVENTION

1. Field of the Invention

The present invention relates to a polishing slurry containing an inorganic boron compound, and particularly to a polishing slurry suitable for polishing a substrate containing Al.

2. Description of the Related Art

It is known that substrates such as single-crystal sapphire substrates containing aluminum (hereinafter may be referred to as Al) have very high hardness and therefore cannot be polished at high polishing rates (for example, as in Patent Literature 1). As a result, when an Al-containing, high hardness substrate is sometimes polished with use of abrasive grains such as diamond which have a higher hardness than that of the material to be polished (for example, as in Patent Literature 2), many scratches may be formed on the polished surface and the polished surface is likely to have a deteriorated surface roughness.

On the other hand, as a method for providing a polished surface of high accuracy, a method for chemical and mechanical polishing by using a polishing slurry composed of a compound containing a specific element is known (for example, Patent Literature 3). Patent Literature 3 proposes polishing of surfaces of a silicon-containing substrate by using a compound containing boron atoms in the chemical structure.

Meanwhile, recently there has been a strong demand for a method for polishing Al-containing substrates such as single-crystal sapphire substrates, which is capable of providing a highly accurate polished surface at high polishing rates. However, to the present inventors' knowledge, no polishing technique can meet the demand at present.

### PRIOR ART DOCUMENTS

### Patent Literature

### [Patent Literature 1] Japanese Patent Application Laid-Open No. 2009-297818

### [Patent Literature 2] Japanese Patent Application Laid-Open No. 2009-263534

### [Patent Literature 3] Japanese Patent Application Laid-Open No. 2010-67681

### SUMMARY OF THE INVENTION

### Problems to be Solved by the Invention

The present invention has been made under such circumstances and aims at providing a polishing technique capable of polishing, at a high speed, a substrate containing Al and having high hardness, such as single-crystal sapphire substrate, and capable of providing a polished surface of high accuracy.

### Means for Solving the Problems

The present inventors have conducted intensive studies on a polishing slurry containing a boron compound, and have discovered a phenomenon that when the boron compound is an inorganic boron compound, boron atoms chemically act on Al and help to remove Al at the atomic level; then the present inventors have found that substrates containing Al can be polished at high polishing rates with high accuracy of polished surfaces, and have completed the present invention.

The present invention relates to a polishing slurry for polishing a substrate containing aluminum, comprising abrasive grains, an inorganic boron compound having a solubility in water at 20° C. of 0.1 g/100 g-H₂O or more, and water. The polishing slurry of the present invention is capable of polishing a substrate containing Al at high polishing rates to provide a very smooth polished surface. In particular, the polishing slurry is very suitable for polishing a substrate containing aluminum oxide, or a single-crystal sapphire substrate.

It is considered that the reason why the polishing slurry of the present invention is capable of polishing a substrate containing aluminum at high polishing rates with high accuracy of polished surfaces is that a chemical reaction as described below will occur when a sapphire (Al₂O₃) substrate is polished, for example, with use of boron oxide or boric acid.

2Al₂O₃+B₂O₃→Al₄B₂O₉

2Al₂O₃+2H₃BO₃→Al₄B₂O₉+3H₂O

It is thought that the occurrence of the chemical reaction helps to remove aluminum from the surface of a sapphire (Al₂O₃) substrate at the atomic level. The chemical reaction is caused by an inorganic boron compound but not by an organic boron compound. Therefore, the boron compound in the present invention needs to be an inorganic boron compound.

The inorganic boron compound in the polishing slurry according to the present invention has a solubility in water at 20° C. of 0.1 g/100 g-H₂O or more. When the solubility is less than 0.1 g/100 g-H₂O, the inorganic boron compound which has not been dissolved in water is likely to cause polishing scratches. Preferred inorganic boron compounds include boron oxide (B₂O₃), boric acid (H₃BO₃), sodium tetraborate and sodium perborate (sodium beroxoborate). The solubility of inorganic boron compound is preferably 0.5 g/100 g-H₂O or more, more preferably 1.0 g/100 g-H₂O or more.

While various substances such as zirconium oxide, manganese oxide, cerium oxide, titanium oxide, zinc oxide and silicon oxide may be used as the abrasive grains in the polishing slurry according to the present invention, cerium oxide, titanium oxide and zinc oxide are preferred, and cerium oxide is particularly preferred. For the particle size of the abrasive grains, the abrasive grains have an average particle size D₅₀ of preferably 0.02 to 3.0 μm, more preferably 0.05 to 2.5 μm. When the abrasive grains have an average particle size D₅₀ of less than 0.02 μm, the polishing rate is likely to be low. When the abrasive grains have an average particle size D₅₀ of more than 3.0 μm, the accuracy of the polished surface (Ra) is likely to be reduced.

In the present invention, it is preferable that the content of the inorganic boron compound is 0.1% by mass to 20% by mass in terms of boron atoms based on the polishing slurry. When the content is less than 0.1% by mass, the chemical action caused by boron atoms is too much diminished to result in a failure of carrying out good polishing. When the content is more than 20% by mass, it is likely that more abrasive grains remain in the polished surface and therefore the polished surface has a high surface roughness. The content of the inorganic boron compound is more preferably 0.5% by mass to 10% by mass, and even more preferably 0.7% by mass to 5% by mass.

In the present invention, it is suitable that a substrate containing aluminum is polished with a polishing slurry comprising abrasive grains, an inorganic boron compound having a solubility in water at 20° C. of 0.1 g/100 g-H₂O or more, and water.

### Advantageous Effect of Invention

As described above, the polishing slurry according to the present invention is capable of polishing, at a high speed, a substrate containing Al and having high hardness, such as single-crystal sapphire substrate, and capable of providing a polished surface of high accuracy.

### DETAILED DESCRIPTION OF THE PREFERRED EMBODIMENTS

Hereinafter, embodiments of the present invention will be described in detail.

### First Embodiment

The first embodiment describes a case where cerium oxide was used as the abrasive grains and boron oxide (B₂O₃) was used as the inorganic boron compound.

A commercially available cerium oxide slurry containing 10% by mass of cerium oxide (made by MITSUI MINING & SMELTING CO., LTD.: MIREK H510C, average particle size D₅₀ 0.11 μm, CeO₂/TREO 99% by mass or more) was used as the abrasive grains. The cerium oxide slurry and boron oxide were dispersed in water to prepare a polishing slurry (having a cerium oxide concentration of 5% by mass). Polishing slurries in which the respective boron oxide contents were adjusted as described in Table 1 were prepared. Then polishing tests for polishing a sapphire substrate were carried out.

In the polishing test, a polishing tester (Model HSP-2I, made by Taito Seiki Co., Ltd.) was used. With supplying the respective polishing slurries to the surface of the object to be polished, the object was polished with a polishing pad. In this polishing test, the polishing slurry was supplied at a rate of 5 L/min. A sapphire substrate having a diameter of 2 inches and a thickness of 0.25 mm (a surface roughness Ra before polishing of 2 nm (20 Å)) was used as the object to be polished. A polishing pad made of polyurethane was used. The substrate was polished at a pressure of the polishing pad to the surface to be polished of 570 g/cm² and a rotation speed of the polishing tester of 60 min⁻¹ (rpm) for 180 minutes.

Polishing rate: The weights of the sapphire substrate before and after the polishing were measured to determine the amount of decrease due to the polishing, and the amount of decrease was converted into thickness to calculate the polishing rate.
Surface roughness Ra: For the surface roughness Ra, the surface of the substrate (measurement area 10 μm×10 μm) was measured with an AFM (atomic force microscope: Nanoscope IIIa made by Veeco Instruments Inc.).

For comparison, sapphire substrates were polished with use of a polishing slurry in which the content of the inorganic boron compound was out of the range of the present invention (Table 1, Comparative Examples 1 to 3), or a polishing slurry containing colloidal silica (silicon oxide/SiO₂, Comparative Example 4 in Table 2) which has been traditionally used for polishing sapphire substrates. The polishing slurry containing colloidal silica used in Comparative Example 4 had an average particle size D₅₀ of 0.08 μm and a colloidal silica concentration of 5% by mass.

TABLE 1

| | Boron oxide | Surface | Polishing |
|---|---|---|---|
| | (in terms of B, % | roughness | rate |
| | by mass) | Ra (nm) | (nm/min) |
| Comparative | 0 | 0.914 | 2.9 |
| Example 1 | | | |
| Comparative | 0.05 | 0.120 | 3.9 |
| Example 2 | | | |
| Example 1 | 0.1 | 0.073 | 10.9 |
| Example 2 | 0.2 | 0.072 | 10.5 |
| Example 3 | 0.5 | 0.060 | 16.0 |
| Example 4 | 0.7 | 0.059 | 22.2 |
| Example 5 | 1.55 | 0.069 | 26.6 |
| Example 6 | 3 | 0.064 | 25.6 |
| Example 7 | 5 | 0.069 | 25.0 |
| Example 8 | 10 | 0.072 | 22.7 |
| Example 9 | 20 | 0.075 | 24.3 |
| Comparative | 30 | 0.193 | 24.0 |
| Example 3 | | | |

TABLE 2

| | | Surface | Polishing |
|---|---|---|---|
| | Abrasive | roughness Ra | rate |
| | grains | (nm) | (nm/min) |
| Comparative | Colloidal silica | 0.098 | 10.0 |
| Example 4 | | | |

As shown in Table 1, there was little progress in the polishing with the polishing slurry of Comparative Example 1 to which no boron oxide was added. In Comparative Examples 2 and 3 in which the content of the inorganic boron compound was out of the range of the present invention, the polished surface had a surface roughness Ra of more than 0.1 nm. On the other hand, in the case of the polishing slurries of Examples 1 to 9, the resulting polished surfaces were smoother than that formed by polishing with colloidal silica in Comparative Example 4. The polishing rates were also found to be higher.

### Second Embodiment

The second embodiment describes a case where boric acid, sodium tetraboron and sodium perborate (sodium beroxoborate) were used as the inorganic boron compounds. The conditions for preparing the polishing slurries were the same as those in Examples 1 to 9 in the above first embodiment. The content of the inorganic boron compounds was adjusted to be the same as that in Example 5 (in terms of boron). Also, the conditions of the polishing test were the same as those in the above first embodiment. Table 3 shows the results of the polishing rate and the surface roughness of the polished surface. Table 3 also shows the results of Example 5 and Comparative Example 1 of the above first embodiment for comparison.

TABLE 3

| | | | Surface | |
|---|---|---|---|---|
| | Inorganic boron compound | | roughness | Polishing rate |
| | (in terms of B, % by mass) | | (nm) | (nm/min) |
| Comparative | — | 0 | 0.914 | 2.9 |
| Example 1 | | | | |
| Example 5 | Boron oxide | 1.55 | 0.069 | 26.6 |
| Example 10 | Boric acid | 1.55 | 0.072 | 18.9 |
| Example 11 | Sodium tetraboron | 1.55 | 0.069 | 16.4 |
| Example 12 | Sodium perborate | 1.55 | 0.079 | 15.3 |

As shown in Table 3, it has been found that when boric acid, sodium tetraboron and sodium perborate were used as the inorganic boron compound, polishing equal to or superior to that in the case of using boron oxide was achieved. This has proved that the inorganic boron compound in the present invention is not limited to boron oxide, and various inorganic boron compounds may be used.

### Third Embodiment

The third embodiment describes a case where silicon oxide (SiO₂, colloidal silica), titanium oxide (TiO₂) and zinc oxide (ZnO) were used as the abrasive grains and boron oxide was used as the inorganic boron compound.

As the abrasive grains, titanium oxide (average particle size D₅₀ 1.2 μm, made by KANTO CHEMICAL CO., INC.) and zinc oxide (average particle size D₅₀ 0.3 μm, made by KANTO CHEMICAL CO., INC.) were used. Also, the same silicon oxide as used in Comparative Example 4 was used. The conditions for preparing the polishing slurries were the same as those in the above first embodiment. The content of the inorganic boron compounds was adjusted to be the same as that in Example 5 (in terms of boron). Also, the conditions of the polishing test were the same as those in the above first embodiment. For comparison, the polishing slurries to which no inorganic boron compound was added were also evaluated. Table 4 shows the results of the polishing rate and the surface roughness of the polished surface. Table 4 also shows the result of the above Comparative Example 4.

TABLE 4

| | | Boron oxide | Surface | |
|---|---|---|---|---|
| | Abrasive | (in terms of | roughness | Polishing rate |
| | grains | B, % by mass) | (nm) | (nm/min) |
| Comparative | SiO₂ | 0 | 0.098 | 10.0 |
| Example 4 | | | | |
| Example 13 | | 1.55 | 0.070 | 19.8 |
| Comparative | TiO₂ | 0 | 1.122 | 1.3 |
| Example 5 | | | | |
| Example 14 | | 1.55 | 0.077 | 11.3 |
| Comparative | ZnO | 0 | 2.991 | 1.9 |
| Example 6 | | | | |
| Example 15 | | 1.55 | 0.085 | 14.4 |

As shown in Table 4, it has been found that when silicon oxide, titanium oxide and zinc oxide were used as the abrasive grains, polishing equal to that in the case of using cerium oxide as abrasive grains was achieved. This has proved that the abrasive grains used for the polishing slurry of the present invention are not limited to cerium oxide, and various abrasive grains may be used.

### INDUSTRIAL APPLICABILITY

According to the present invention, substrates containing Al which are difficult to be polished, more specifically, single-crystal sapphire substrates, can be polished at high speed and high surface accuracy.

1. A polishing slurry for polishing a substrate containing aluminum, comprising abrasive grains, an inorganic boron compound having a solubility in water at 20° C. of 0.1 g/100 g-H₂O or more, and water.

2. The polishing slurry according to claim 1, wherein a content of the inorganic boron compound is 0.1% by mass to 20% by mass in terms of boron atoms based on the polishing slurry.

3. The polishing slurry according to claim 1, wherein the aluminum contained in the substrate is aluminum oxide.

4. A polishing method, comprising polishing a substrate containing aluminum by using a polishing slurry composed of abrasive grains, an inorganic boron compound having a solubility in water at 20° C. of 0.1 g/100 g-H₂O or more, and water.

5. The polishing slurry according to claim 2, wherein the aluminum contained in the substrate is aluminum oxide.
